(19) United States
(12) Patent Application Publication
(10) Pub. No.: US 2014/0168188 A1
(43) Pub. Date: Jun. 19, 2014

(54) ORGANIC LIGHT EMITTING DISPLAY DEVICE AND DRIVING METHOD THEREOF

(71) Applicant: Samsung Display Co., Ltd., Yongin-City (KR)

(72) Inventors: Byung-Geun Jun, Yongin-City (KR); In-Hwan Kim, Yongin-City (KR); Min-Cheol Kim, Yongin-City (KR)

(73) Assignee: Samsung Display Co., Ltd., Yongin-City (KR)

(21) Appl. No.: 13/897,305

(22) Filed: May 17, 2013

(30) Foreign Application Priority Data
Dec. 14, 2012 (KR) 10-2012-0146484

(51) Int. Cl. G09G 3/32

(52) U.S. Cl. CPC G09G 3/3291
USPC 345/212; 345/76

(57) ABSTRACT

An organic light emitting display device and a driving method thereof that can stably compensate for a threshold voltage of a driving transistor. The organic light emitting display device includes pixels positioned at intersection portions (crossing regions) of scan lines and data lines, each pixel including the driving transistor having a gate electrode initialized to a voltage of an initialization power source before a data signal is supplied; power source lines coupled to the pixels in a column direction parallel with the data lines; and an initialization power source generator generating the initialization power source to the pixels via the power source lines. In the organic light emitting display device, the initialization power source generator controls the voltage of the initialization power source supplied to each pixel, corresponding to the gray scale of the data signal to be supplied to the pixel.

### CROSS-REFERENCE TO RELATED APPLICATION

This application claims priority to and the benefit of Korean Patent Application No. 10-2012-0146484, filed on Dec. 14, 2012, in the Korean Intellectual Property Office, the entire content of which is incorporated herein by reference.

### BACKGROUND

1. Field

An aspect of the present invention relates to an organic light emitting display device and a driving method thereof.

2. Description of the Related Art

Recently, there have been developed various types of flat panel display devices having reduced weight and volume as compared with cathode ray tubes. These flat panel display devices include a liquid crystal display, a field emission display, a plasma display panel, an organic light emitting display device, and the like.

Among these flat panel display devices, the organic light emitting display device displays images using organic light emitting diodes that emit light through recombination of electrons and holes. The organic light emitting display device has a fast response speed and is driven with low power consumption.

An organic light emitting display device has a plurality of pixels arranged in a matrix form at intersection portions (crossing regions) of a plurality of data lines and a plurality of scan lines. Each of the pixels generally includes an organic light emitting diode, two or more transistors including a driving transistor, and one or more capacitors.

The organic light emitting display device has low power consumption. However, in the organic light emitting display device, the amount of current that flows in an organic light emitting diode is changed depending on the variation in the threshold voltage of the driving transistor included in each pixel, and therefore, images with unequal luminance are displayed. That is, characteristics of the driving transistor are changed depending on the fabrication factor of the driving transistor included in each pixel. Practically, it is impossible in the current fabrication process to fabricate the organic light emitting display device so that all transistors of the organic light emitting display device have the same characteristics. Accordingly, the variation in the threshold voltage of the driving transistor occurs.

To solve such a problem, a proposed method adds a compensation circuit including a plurality of transistors and capacitors to each pixel. The compensation circuit compensates for a variation in threshold voltage of a driving transistor by allowing the driving transistor to be diode-coupled during a period in supplying a scan signal.

Meanwhile, a method of driving a panel at a high resolution and/or a high driving frequency has also recently been proposed in order to improve image quality. However, in a case where the panel is driven at the high resolution and/or the high driving frequency, a threshold voltage is not compensated in a low-luminance region, and accordingly, low luminance mura occurs. Specifically, in a case where a low luminance image is implemented, low current flows in a pixel, and accordingly, a threshold voltage is not compensated during a set or predetermined time (a period in supplying a scan signal).

### SUMMARY

Aspects of embodiments are directed toward an organic light emitting display device and a driving method thereof that can stably compensate for a threshold voltage of a driving transistor.

According to an embodiment of the present invention, an organic light emitting display device is provided. The organic light emitting device includes: pixels positioned at intersection portions (crossing regions) of scan lines and data lines, and each pixel including a driving transistor having a gate electrode initialized to the voltage of an initialization power source before a data signal is supplied; power source lines coupled to the pixels in a column direction parallel with the data lines; and an initialization power source generator generating the initialization power source to the pixels via the power source lines, wherein the initialization power source generator controls the voltage of the initialization power source supplied to each pixel to correspond to a gray scale of the data signal to be supplied to the pixel.

The initialization power source may be set to a voltage level lower than that of the data signal. The initialization power source generator may supply the voltage of the initialization power source at a first voltage level to a first pixel receiving the data signal at a low-gray scale data, and supply the voltage of the initialization power source at a second voltage level lower than the first voltage level to a second pixel receiving the data signal at a high-gray scale data. The initialization power source generator may receive a data input from the outside thereof so as to detect the gray scale of the data signal.

Each pixel may include an organic light emitting diode; the driving transistor controlling the amount of current supplied to the organic light emitting diode; and a second transistor coupled between the gate electrode of the driving transistor and the power source line. Each pixel may further include a third transistor allowing the first transistor to be diode-coupled.

According to an embodiment of the present invention, a driving method of an organic light emitting display device is provided. The driving method includes: supplying a voltage of an initialization power source to a gate electrode of a driving transistor; and supplying a data signal to the gate electrode of the driving transistor after the initialization power source is supplied, wherein the voltage of the initialization power source is set to correspond to the gray scale of the data signal.

The voltage of the initialization power source at a first voltage level may be supplied when the data signal corresponding to a low gray scale is supplied, and the voltage of the initialization power source at a second voltage level may be supplied when the data signal corresponding to a high gray scale is supplied.

In the organic light emitting display device and the driving method thereof according to embodiments of the present invention, the voltage of an initialization power source supplied to each pixel is controlled, corresponding to the gray scale of the data signal. That is, in embodiments of the present invention, the voltage of the initialization power source is set in consideration of the rate of increase in voltage of each pixel corresponding to the gray scale of the data signal, and accordingly, the threshold voltage of the driving transistor can be stably compensated.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram illustrating an organic light emitting display device according to an embodiment of the present invention.

FIG. 2 is a graph illustrating an embodiment of an initialization power source generated by an initialization power source generator shown in FIG. 1.

FIG. 3 is a block diagram illustrating an embodiment of a pixel shown in FIG. 1.

FIG. 4 is a waveform diagram illustrating driving waveforms supplied to the pixel shown in FIG. 3.

### DETAILED DESCRIPTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to a complete understanding of the invention are omitted for clarity. Also, like reference numerals refer to like elements throughout.

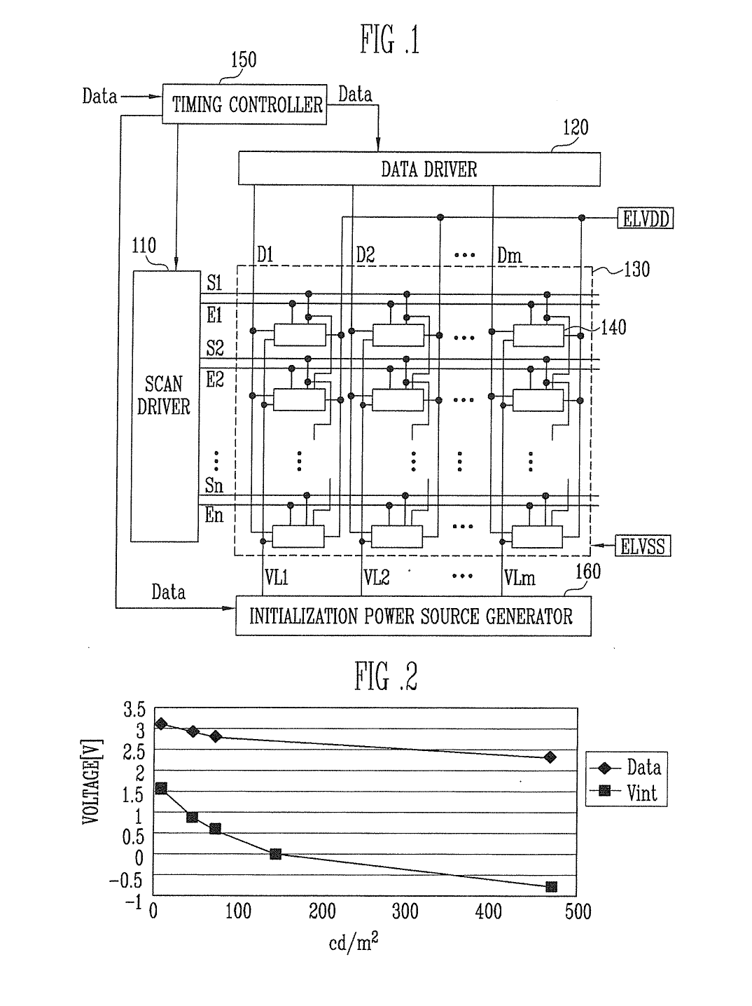

FIG. 1 is a block diagram illustrating an organic light emitting display device according to an embodiment of the present invention.

Referring to FIG. 1, the organic light emitting display device according to this embodiment includes: a pixel unit 130 having pixels 140 positioned at intersection portions (crossing regions) of scan lines S1 to Sn, data lines D1 to Dm and power source lines VL1 to VLm; a scan driver 110 driving the scan lines S1 to Sn and emission control lines E1 to En; a data driver 120 driving the data lines D1 to Dm; an initialization power source generator 160 driving the power source lines VL1 to VLm; and a timing controller 150 controlling the scan driver 110, the data driver and the initialization power source generator 160.

The timing controller 150 controls the scan driver 110, the data driver 120 and the initialization power source generator 160, corresponding to synchronization signals supplied from the outside thereof. The timing controller 150 supplies data Data supplied from the outside to the data driver 120 and the initialization power source generator 160.

The scan driver 110 supplies a scan signal to the scan lines S1 to Sn. For example, the scan driver 110 progressively supplies the scan signal to the scan lines S1 to Sn. The scan driver 110 supplies an emission control signal to the emission control lines E1 to En. For example, the scan driver 110 progressively supplies the emission control signal to the emission control lines E1 to En. Here, the emission control signal and the scan signal may be supplied at various times, corresponding to the structure of the pixel 140. For example, the emission control signal supplied to an i-th (i is a natural number) emission control line Ei may be supplied to overlap with the scan signal supplied to an (i−1)-th and i-th scan lines Si−1 and Si.

The data driver 120 generates data signals, corresponding to the data Data supplied from the timing controller 150. The data driver 120 supplies data signals to the data lines D1 to Dm in synchronization with the scan signal.

The pixel unit 130 receives a first power source ELVDD and a second power source ELVSS, supplied from the outside thereof, and supplies the first and second power sources ELVDD and ELVSS to each pixel 140. Each pixel 140 has a driving transistor so as to control the amount of current supplied from the first power source ELVDD to the second power source ELVSS via an organic light emitting diode (not shown), corresponding to the data signal. A gate electrode of the driving transistor is initialized to the voltage of an initialization power source Vint before the data signal is supplied.

The power source lines VL1 to VLm are formed in a direction intersecting (crossing) the scan lines S1 to Sn, i.e., a column direction. The power source lines VL1 to VLm provide the pixels 140 with the initialization power source Vint supplied from the initialization power source generator 160.

The initialization power source generator 160 receives the data Data supplied from the timing controller 150, and controls the voltage of the initialization power source Vint supplied to each of the power source lines VL1 to VLm, corresponding to the supplied data Data. In practice, the initialization power source generator 160 supplies initialization power sources Vint set to different voltages, corresponding to the voltages of data signals supplied to the respective pixels 140, i.e., gray scale values.

More specifically, the initialization power source generator 160 receives data Data, corresponding to the respective pixels 140. Here, the data Data may be supplied from the data driver 120 to the initialization power source generator 160. The initialization power source generator 160 receiving the data Data controls the voltage of the initialization power source Vint supplied to each pixel 140, corresponding to the gray scale value of data supplied to each pixel 140. For example, the initialization power source generator 160, as shown in FIG. 2, may control the voltage of the initialization power source Vint to be lowered as the gray scale of a data signal is changed from a low gray scale to a high gray scale.

In a case where the driving transistor included in each pixel 140 is implemented as a PMOS transistor, the voltage of the data signal is set to be high in the low gray scale, and is set to be low in the high gray scale. Therefore, in a case where the initialization power source Vint is fixed, the rate of increase in voltage of the driving transistor in the pixel implementing the low gray scale is necessarily set to be higher than that of increase in voltage of the driving transistor in the pixel implementing the high gray scale. However, since a small amount of current flows in the pixel implementing the low gray scale, the voltage of the gate electrode of the driving transistor is not increased to a desired voltage, and therefore, the display quality of the pixel is deteriorated.

In order to solve such a problem, in an embodiment of the present invention, the initialization power source generator 160 controls the voltage of the initialization power source Vint to be lowered as the gray scale of a data signal is changed from the low gray scale to the high gray scale. In this case, the data signal and the initialization power source Vint are set to have a low voltage difference in the low gray scale. If the data signal and the initialization power source Vint are set to have a low voltage difference in the low gray scale as described above, the voltage of the gate electrode of the driving transistor can be stably increased from the voltage of the initialization power source Vint to the voltage of the data signal, corresponding to the small amount of current in the low gray scale. That is, in the present invention, the threshold voltage of the driving transistor can be stably compensated in the pixel 140 even when low luminance is expressed.

Meanwhile, the voltage of the data signal in the high gray scale is lowered as compared with that of the data signal in the low gray scale, and accordingly, the voltage of the initialization power source Vint in the high gray scale is set to be lowered as compared with that of the initialization power source Vint in the low gray scale. Additionally, in the high gray scale, higher current flows as compared with that in the low gray scale. Thus, although the voltage of the initialization power source Vint is lowered, the voltage of the gate electrode of the driving transistor can be stably increased to a desired voltage, corresponding to the large amount of current.

As described above, in an embodiment of the present invention, the voltage of the initialization power source Vint supplied to each pixel 140 is controlled, corresponding to the gray scale value of the pixel 140, and accordingly, the threshold voltage of the driving transistor can be stably compensated.

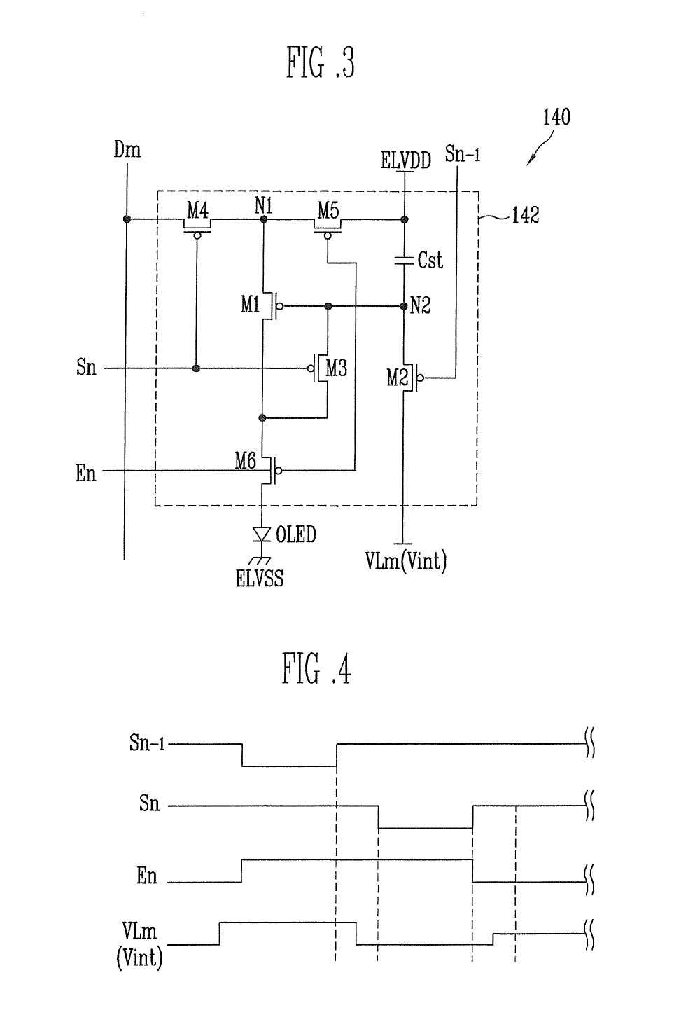

FIG. 3 is a block diagram illustrating an embodiment of the pixel shown in FIG. 1. Although it has been illustrated in FIG. 3 that the pixel has six transistors and one capacitor, the present invention is not limited thereto. In practice, the present invention can be applied to various types of pixels in which a driving transistor M1 is diode-coupled to compensate for a threshold voltage of the driving transistor M1.

Referring to FIG. 3, the pixel 140 according to this embodiment includes an organic light emitting diode OLED, and a pixel circuit 142 coupled to a data line Dm, scan lines Sn−1 and Sn and an emission control line En so as to control the amount of current supplied to the organic light emitting diode OLED.

An anode electrode of the organic light emitting diode OLED is coupled to the pixel circuit 142, and a cathode electrode of the organic light emitting diode OLED is coupled to the second power source ELVSS. Here, the voltage of the second power source ELVSS is set to be lower than that of the first power source ELVDD. The organic light emitting diode OLED generates light with a set or predetermined luminance, corresponding to the amount of current supplied from the pixel circuit 142.

When a scan signal is supplied to the scan line Sn, the pixel circuit 142 controls the amount of current supplied to the organic light emitting diode OLED, corresponding to the data signal supplied to the data line. To this end, the pixel circuit 142 includes first to sixth transistors M1 to M6 and a storage capacitor Cst.

A first electrode of the fourth transistor M4 is coupled to the data line Dm, and a second electrode of the fourth transistor M4 is coupled to a first node N1. A gate electrode of the fourth transistor M4 is coupled to the n-th scan line Sn. When the scan signal is supplied to the n-th scan line Sn, the fourth transistor M4 is turned on to supply, to the first node N1, the data signal supplied to the data line Dm.

A first electrode of the first transistor M1 is coupled to the first node N1, and a second electrode of the first transistor M1 is coupled to a first electrode of the sixth transistor M6. A gate electrode of the first transistor M1 is coupled to a second node N2. The first transistor M1 supplies, to the organic light emitting diode OLED, a current corresponding to the voltage charged in the storage capacitor Cst.

A first electrode of the third transistor M3 is coupled to the second electrode of the first transistor M1, and a second electrode of the third transistor M3 is coupled to the second node N2. A gate electrode of the third transistor M3 is coupled to the n-th scan line Sn. When the scan signal is supplied to the n-th scan line Sn, the third transistor M3 is turned on so that the first transistor M1 is diode-coupled.

The second transistor M2 is coupled between the second node N2 and a power source line VLn. A gate electrode of the second transistor M2 is coupled to the (n−1)-th scan line Sn−1. When the scan signal is supplied to the (n−1)-th scan line Sn−1, the second transistor M2 is turned on to receive an initialization power source Vint supplied from the initialization power source generator 160 via the power source line VLn. Here, the voltage of the initialization power source Vint is set to a voltage lower than that of the data signal.

A first electrode of the fifth transistor M5 is coupled to the first power source ELVDD, and a second electrode of the fifth transistor M5 is coupled to the first node N1. A gate electrode of the fifth transistor M5 is coupled to the emission control line En. When no emission control signal is supplied from the emission control line En, the fifth transistor M5 is turned on to electrically connect the first power source ELVDD and the first node N1 to each other.

A first electrode of the sixth transistor M6 is coupled to the second electrode of the first transistor M1, and a second electrode of the sixth transistor M6 is coupled to the anode electrode of the organic light emitting diode OLED. A gate electrode of the sixth transistor M6 is coupled to the emission control line En. When no emission control signal is supplied from the emission control line En, the sixth transistor M6 is turned on to supply, to the organic light emitting diode OLED, a current supplied from the first transistor M1.

FIG. 4 is a waveform diagram illustrating driving waveforms supplied to the pixel shown in FIG. 3.

Referring to FIG. 4, the scan signal is supplied to the (n−1)-th scan line Sn−1 so that the second transistor M2 is turned on. If the second transistor M2 is turned on, the voltage of the initialization power source Vint is supplied to the second node N2.

Here, the voltage of the initial power source Vint is set, corresponding to the gray scale of a data signal to be supplied to the pixel 140. That is, in a case where a low gray scale is implemented in the pixel 140, the voltage of the initialization power source Vint is set to a high voltage. In a case where a high gray scale is implemented in the pixel, the voltage of the initialization power source Vint is set to a low voltage.

After the voltage of the initialization power source Vint at the second node N2 is supplied, the scan signal is supplied to the n-th scan line Sn. If the scan signal is supplied to the n-th scan line Sn, the third and fourth transistors M3 and M4 are turned on. If the fourth transistor M4 is turned on, the data signal supplied to the data line Dm is supplied to the first node N1. In this case, the second node N2 is initialized to the voltage of the initialization power source Vint, and hence the first transistor M1 is turned on. Then, the data signal supplied to the first node N1 is supplied to the second node N2 via the diode-coupled first transistor M1. The voltage at the second node N2 is increased to a voltage obtained by subtracting the threshold voltage of the first transistor M1 from the voltage of the data signal.

Meanwhile, since the voltage of the initialization power source Vint is determined, corresponding to the gray scale value of the pixel 140, the voltage at the second node N2 is stably increased to a desired voltage. That is, in one embodiment of the present invention, the voltage of the initialization power source Vint is set, corresponding to the gray scale value of the pixel 140, and accordingly, the threshold voltage of the first transistor M1 can be stably compensated.

The voltage applied to the second node N2 is stored in the storage capacitor Cst. After a set or predetermined voltage is charged in the storage capacitor Cst, the supply of the emission control signal to the emission control line En is stopped so that the fifth and sixth transistors M5 and M6 are turned on. If the fifth and sixth transistors M5 and M6 are turned on, a current path from the first power source ELVDD to the organic light emitting diode OLED is formed. In this case, the first transistor M1 controls the amount of current flowing from the first power source ELVDD to the organic light emitting diode OLED, corresponding to the voltage charged in the storage capacitor Cst.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device, comprising:
a plurality of pixels positioned at crossing regions of scan lines and data lines, each pixel including a driving transistor comprising a gate electrode configured to be initialized to a voltage of an initialization power source before a data signal is supplied;
a plurality of power source lines coupled to the pixels in a direction parallel with the data lines; and
an initialization power source generator for generating the initialization power source to the pixels via the power source lines,
wherein the initialization power source generator is configured to control the voltage of the initialization power source supplied to each pixel to correspond to a gray scale of the data signal to be supplied to the pixel.

2. The organic light emitting display device of claim 1, wherein the initialization power source is set to a voltage level lower than that of the data signal.

3. The organic light emitting display device of claim 1, wherein the initialization power source generator is configured to supply the voltage of the initialization power source at a first voltage level to a first pixel of the pixels receiving the data signal at a low-gray scale, and supply the voltage of the initialization power source at a second voltage level lower than the first voltage level to a second pixel of the pixels receiving the data signal at a high-gray scale.

4. The organic light emitting display device of claim 1, wherein the initialization power source generator is configured to receive a data input from the outside thereof so as to detect the gray scale of the data signal.

5. The organic light emitting display device of claim 1, wherein each pixel includes:
an organic light emitting diode;
the driving transistor for controlling an amount of current supplied to the organic light emitting diode; and
a second transistor coupled between the gate electrode of the driving transistor and the power source line.

6. The organic light emitting display device of claim 5, wherein each pixel further includes a third transistor for allowing the driving transistor to be diode-coupled.

7. A driving method of an organic light emitting display device, the method comprising:
supplying a voltage of an initialization power source to a gate electrode of a driving transistor; and
supplying a data signal to the gate electrode of the driving transistor after the initialization power source is supplied,
wherein the voltage of the initialization power source is set to correspond to a gray scale of the data signal.

8. The driving method of claim 7, wherein the voltage of the initialization power source at a first voltage level is supplied when the data signal corresponding to a low gray scale is supplied, and the voltage of the initialization power source at a second voltage level is supplied when the data signal corresponding to a high gray scale is supplied.

9. The driving method of claim 8, wherein the second voltage level is lower than the first voltage level.

10. A driving system of an organic light emitting display device, the system comprising:
means for supplying a voltage of an initialization power source to a gate electrode of a driving transistor; and
means for supplying a data signal to the gate electrode of the driving transistor after the initialization power source is supplied,
wherein the voltage of the initialization power source is set to correspond to a gray scale of the data signal.
